(19) United States
(12) Patent Application Publication
(10) Pub. No.: US 2005/0203795 A1
(43) Pub. Date: Sep. 15, 2005

(54) Method for providing discounted media placement and marketing services to a plurality of advertisers

(76) Inventor: Kristin Witzenburg, Redondo Beach, CA (US)

Correspondence Address: TOPE-MCKAY & ASSOCIATES, 23852 PACIFIC COAST HIGHWAY #311, MALIBU, CA, 90265, US

(21) Appl. No.: 10/798,640

(22) Filed: Mar. 11, 2004

(51) Int. Cl. G06F 17/60

(52) U.S. Cl. 705/14

(57) ABSTRACT

The present invention relates a method, system, and computer program product for providing discounted media placement and marketing services to a plurality of advertisers. The present invention comprises receiving a large block of media at a volume-discounted price from a media provider; dividing the large block of media into a plurality of smaller media blocks; and providing the plurality of smaller media blocks to a plurality of advertisers. Through receiving and dividing the large block of media into a plurality of smaller media blocks, the plurality of advertisers are able to receive leveraged media placement at a volume-discounted price.

### BACKGROUND OF INVENTION

(1) Field of Invention

The present invention relates to the provision of discounted media placement and marketing services to a plurality of advertisers, and more particularly, to techniques for receiving and dividing a large block of media into a plurality of smaller media blocks, where a plurality of advertisers are able to receive media placement at a volume-discounted price.

(2) Description of Related Art

In the current world of advertising, advertisers either advertise individually or pool their money for a common campaign. Although advertisers who advertise individually have an opportunity to expose their unique brand and message to consumers, this approach is costly. Most companies do not have media budgets large enough to gain financial leverage. Additionally, because they often do not have marketing consultants or media buyers who can place savvy media buys with targeted, effective strategies, they are generally required to go to an ad agency. The combination of small budgets and limited expertise generally produces poor results. This disadvantage also applies to agencies and media companies. When advertisers experience low response rates (i.e. poor results), it becomes difficult for agencies and media companies to maintain existing clients or to attract new clients. Constantly losing and attracting new clients translates into additional overhead expenses because of the burden of managing multiple clients, higher costs in salaries/commissions generally associated with new business (as compared to repeat business), and expenses associated with new client operational learning curves.

Advertisers who pool their money and hire an agency have the opportunity to gain leverage through the development of a strategic plan and message, selecting a commodity theme that represents all of them. Examples of these include “Got Milk?” and 1-800-DENTIST. A disadvantage of group media purchase campaigns is that individual participants do not have the opportunity to expose their unique brand and message. Each participant forfeits individual results for the good of the commodity, such as raising awareness of milk or providing one access point for finding a dentist. Although the media provider gains advantages from having one buyer (the agency) and achieves good results from the planning and leverage, they miss out on the benefits associated with having depth in their client base, which would include individual advertiser results and long term relationships with businesses.

Frequently individual media will organize a special section dedicated to an industry, business segment, neighborhood of shops, destination, etc. For example, the Los Angeles Magazine may present a special advertising section to the City of Santa Monica and then sell advertising space to individual advertisers to create a cooperative section. Disadvantages of this approach are that the media provider selects itself as the media outlet, and that the advertisers don't receive the benefit of a strategic approach developed with their business objectives in mind. This approach also includes disadvantages from the perspective of the media provider, who must continually invest in developing and testing these concepts in the market.

Advertising and marketing is often the largest single expense item in any successful business. There is a disadvantage in the marketplace to small businesses that is a direct result of the advantages derived from economies of scale afforded by large businesses. Bigger businesses have bigger advertising budgets and can therefore afford advertising agencies, strategic marketing personnel, and larger media purchases. Therefore bigger businesses have more effective, higher response rate, and more cost efficient advertising programs. Small to mid size businesses—approximately eighty (80) percent of all businesses—pay the market tax, meaning that they have smaller budgets, more ineffective programs, and more expensive programs.

As an example, consider that a full page advertisement in the Los Angeles Magazine may cost $15,000. On the other hand, a ⅙ page advertisement in the same magazine may cost $6,000. In this example, six advertisers who each purchase ⅙ of advertising space, provide $36,000 revenue to the magazine, whereas an advertiser who purchases a full page of advertising space provides $15,000 revenue to the magazine. The revenue difference of $21,000 is a trade off made by the magazine and the advertisers that both must accept for of all of the reasons listed above in the previous paragraph. This same concept spreads across nearly all media—radio, television, the Internet, trade shows, billboards, sponsorship opportunities, paid placement on television, and more.

For reasons stated above, an ability to cut expense and at the same time improve results would have a dramatic effect on business performance. Thus, there exists a need in the marketplace for lower cost advertising that delivers leveraged results.

### SUMMARY OF INVENTION

The present invention relates a method for providing discounted media placement and marketing services to a plurality of advertisers. The method comprises acts of acting as an intermediary between a media provider and the plurality of advertisers; receiving a large block of media at a volume-discounted price from a media provider; dividing the large block of media into a plurality of smaller media blocks; providing a first smaller media block to a first advertiser at a first volume-discounted price; and providing a second smaller media block to a second advertiser at a second volume-discounted price. Through receiving and dividing the large block of media into a plurality of smaller media blocks, the plurality of advertisers receive media placement at a volume-discounted price.

In the act of receiving a large block of media at a volume-discounted price from a media provider, the large block of media is received in a form selected from a group consisting of a radio advertisement, a television advertisement, a tradeshow advertisement, a billboard advertisement, an Internet advertisement, a sponsorship advertisement, a print advertisement, television placement, and an Internet keyword.

The act of acting as an intermediary between a media provider and the plurality of advertisers further comprises an act of negotiating directly with the media provider for a discounted price based on volume and an added value of outsourcing sales, management and creative development.

The act of dividing the large block of media into a plurality of smaller media blocks further comprises acts of breaking up the large media block into the plurality of smaller media blocks, where each of the plurality of smaller media blocks is a participation opportunity; and offering the participation opportunity to an advertiser.

In another aspect, the present invention comprises a method for providing discounted marketing services to an advertiser in a specific industry. The method comprises acts of researching a market in a specific industry; developing a media plan for a plurality of advertisers in the specific industry, negotiating directly with a media provider for a discounted price on a large block of media based on volume and an added value of outsourcing sales, management and creative development; dividing the large block of media into a plurality of smaller blocks, where a smaller block of media corresponds with a participation opportunity; and selling the participation opportunity to an advertiser.

The act of researching a market in specific industry further comprises an act of selecting an industry from a group consisting of the financial services industry, the automotive industry, the computer industry, the real estate industry, and the transportation industry. Additionally, the act of developing a media plan for a plurality of advertisers in the specific industry further comprises an act of selecting credit unions as an industry segment within the financial services industry.

In yet another aspect, the present invention relates to an Internet-based method and system for providing discounted Internet media placement to a plurality of advertisers. The method comprises acts of acting as an intermediary between an Internet-based media provider and the plurality of advertisers; selecting and receiving a navigation key from the media provider; developing an exhibit that corresponds to the navigation key and is retrieved when the navigation key is used with the search engine, the exhibit being linked to a jump page; developing a jump page that is opened by clicking on the exhibit; providing a first media placement on the jump page to a first advertiser at a first discounted price; and providing a second media placement on the jump page to a second advertiser at a second discounted price. Through receiving a navigation key that retrieves an exhibit when used with a search engine, and linking the exhibit to a jump page where the plurality of advertisers receive media placement, the plurality of advertisers are able to receive Internet media placement at a discounted price.

The Internet-based method further comprises an act of linking each media placement to a desired website, thereby allowing a user to click on the media placement and load a desired website, each click and load constituting a single click-through.

In another aspect, the Internet-based method further comprises acts of selling a set number of click-throughs to each individual advertiser; removing the individual advertiser's media placement from the jump page when the set number has been reached; notifying the individual advertiser of the removal; offering an opportunity to purchase additional click-throughs; and returning the individual advertiser's media placement to the jump page after having purchased additional click-throughs. Furthermore, the acts of removing the media placement from the jump page and returning the media placement to the jump page are automated.

In yet another aspect, the Internet-based method further comprises acts of providing an Internet-accessible user interface; configuring the user interface to allow each individual advertiser to purchase additional click-throughs; and configuring the user interface to allow each individual advertiser to select media to be placed on the jump page.

Additionally, the method further comprises an act of rotating a plurality of advertisers' exposure on the jump page. The jump page contains space for a predetermined number of media placements such that when that number is exceeded, a plurality of advertisers' presence on the jump page may be rotated, thereby providing additional advertisers with media placement at a volume-discounted price.

It can be appreciated by one in the art that the aforementioned methods can be operated manually, or alternatively, through an automated system utilizing a data processing system and/or a computer program product.

For example, the present invention also comprises an Internet-based system. The Internet-based system comprises a data processing system for storing a jump page. The jump page includes a first media placement for a first advertiser stored at a first discounted price and a second media placement for a second advertiser stored at a second discounted price. The jump page is loaded by clicking on an exhibit that corresponds to a navigation key, where through linking the exhibit to a jump page where a plurality of advertisers receive media placement, the plurality of advertisers receive Internet media placement at a discounted price. The system may also be configured to include the rotating media placements on the jump page, as described above regarding the Internet-based method.

Furthermore, each media placement on the data processing system is linked to a desired website on a corresponding server computer, allowing a user to click on the media placement and load the desired website.

The system also includes a counter that stores the number of click-throughs. When the counter reaches a predetermined level, the advertiser is notified and offered an opportunity to purchase additional click-throughs. Additionally, each individual advertiser purchases a set number of click-throughs, such that when the set number is reached, the system removes the individual advertiser's media placement from the jump page. Through purchasing additional click-throughs, the system returns the individual advertiser's corresponding media placement to the jump page. The system by which the advertisement is removed from the jump page and by which the advertisement is returned to the jump page is automated.

Furthermore, the data processing system further comprises an Internet-accessible user interface, configured to allow each individual advertiser to purchase additional click-throughs and to allow each individual advertiser to select media to be placed on the jump page.

As discussed previously, the present invention also includes a computer program product. The computer program product comprises computer-readable instructions encoded on a computer-readable medium for causing a server computer to: receive input information regarding an advertisement purchased on a search engine; receive requests for media placement from prospective advertisers; sell media placements to the advertisers at a determined price; recieve advertisements from the advertisers to which media placements were sold; receive a download request from a user's computer, where the download request is from a user searching on the search engine; and generate a jump page partitioning an advertising page into a plurality of media placements where, when loaded, the jump page displays media placements purchased by advertisers.

The computer program product further comprises a means for linking each media placement to a corresponding advertiser's website; a means for selling a set number of click-throughs to each individual advertiser; a means for removing the individual advertiser's media placement from the jump page when the set number has been reached; a means for notifying the individual advertiser of the removal and for offering an opportunity to purchase additional click-throughs; and a means for returning the individual advertiser's media placement to the jump page after having purchased additional click-throughs.

In another aspect, the computer program product comprises a means for providing an Internet-accessible user interface; a means for configuring the user interface to allow each individual advertiser to purchase additional click-throughs and to allow each individual advertiser to select media to be placed on the jump page.

Finally, the computer program product comprises a means for rotating a plurality of advertisers' exposure on the jump page, where the jump page contains space for a predetermined number of media placements such that when that number is exceeded, a plurality of advertisers' presence on the jump page is rotated, thereby providing additional advertisers with media placement at a volume-discounted price.

### BRIEF DESCRIPTION OF THE DRAWINGS

The objects, features and advantages of the present invention will be apparent from the following detailed descriptions of the various aspects of the invention, taken in conjunction with reference to the following drawings, where:

FIG. 1 is a flowchart depicting acts in a method for providing discounted media placement to a plurality of advertisers according to the present invention;

FIG. 2 is a flowchart depicting acts in a method for providing discounted marketing services to an advertiser according to the present invention;

FIG. 3 is a flowchart depicting acts in an Internet-based method and system for providing discounted Internet media placement to a plurality of advertisers according to the present invention;

FIG. 4 is an illustration depicting acts in an Internet-based system for providing discounted Internet media placement to a plurality of advertisers according to the present invention;

FIG. 5 is an illustration of a search results page according to the present invention;

FIG. 6 is an illustration of a jump page according to the present invention;

FIG. 7 is an illustration of a user interface according to the present invention;

FIG. 8 is a block diagram of a general computer system for use with the present invention; and

FIG. 9 is an illustrative diagram of a computer-readable medium aspect of the present invention.

### DETAILED DESCRIPTION

The present invention relates a method, system and computer program product for providing discounted media placement and marketing services to a plurality of advertisers, and more particularly, to a method and system for receiving and dividing a large block of media into a plurality of smaller media blocks, where a plurality of advertisers are able to receive media placement at a volume-discounted price.

The following description, taken in conjunction with the referenced drawings is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore, it should be noted that unless explicitly stated otherwise, the figures included herein are illustrated qualitatively and without any specific scale, and are intended to generally present the concept of the present invention.

In order to provide a working frame of reference, first a glossary of terms used in the description and claims is given as a central resource for the reader. Next, a discussion of various principal aspects of the present invention is provided. Finally, a discussion is provided to give an understanding of the specific details of the present invention.

(1) Glossary

Before describing the specific details of the present invention, a centralized location is provided in which various terms used herein and in the claims are defined. The glossary provided is intended to provide the reader with a general understanding for the intended meaning of the terms, but is not intended to convey the entire scope of each term. Rather, the glossary is intended to supplement the rest of the specification in more clearly explaining the terms used.

Advertiser—The term “Advertiser” refers to an entity seeking to purchase a block of media in order to communicate with a market regarding a product, service, or a message such as a political statement.

Block of Media—The term “block of media” refers to an amount of advertising space on any means of mass communication, such as radio, television, a tradeshow, a billboard, Internet, a sponsorship opportunity, television placement, an Internet keyword, etc.

Copy—The term “copy” typically refers to the words to be printed or spoken in an advertisement.

Exhibit—The term “exhibit” refers to any representation concerning an advertisement, non-limiting examples of which include copy, blurbs, music, logos, and multi-media.

Jump Page—The term “jump page” refers to an Internet web page that is created by the marketer and is loaded from a search results page. The jump page contains a plurality of advertisements, where each advertisement may contain a link to a desired website, such as an individual advertiser's website.

Keyword—The term “keyword” refers to a word or words used as a reference point for finding other words or information. A keyword is often used in conjunction with a search engine to locate the relevant search results on a search results page.

Marketer—The term “marketer” refers to any entity providing marketing services to an advertiser, such as purchasing a block of media and placing the advertiser's advertisement in the block of media.

Means—The term “means” as used with respect to this invention generally indicates a set of operations to be performed on a computer, and may represent pieces of a whole program or individual, separable, software modules. Non-limiting examples of “means” include computer program code (source or object code) and “hard-coded” electronics (i.e. computer operations coded into a computer chip). The “means” may be stored in the memory of a computer or on a computer readable medium.

Media—The term “media” refers to any means of mass communication, non-limiting examples of which include radio, television, a tradeshow, a billboard, an Internet advertisement, a sponsorship opportunity, a television placement, an Internet keyword, a magazine, and a newspaper.

Media Plan—The term “media plan” refers to any coherent plan for providing media to an advertiser, non-limiting examples of items in such a plan would include strategy, media purchase, and execution.

Navigation Key—The term “navigation key” refers to any key for navigating a website, non-limiting examples of which include keywords and other types of navigation such as categorical link-based navigation. The navigation key is typically used in conjunction with a search engine to locate the relevant search results on a search results page.

Participation Opportunity—The term “participation opportunity” refers to a smaller block of media subdivided from a larger block of media.

Search Results Page—The term “search results page” refers to a page on a website that is generated by a search engine to display search results applicable to a corresponding navigation key. The search results page may include at least one placement for advertising which is purchased by the marketer and linked to a jump page.

(2) Principal Aspects

The present invention has three “principal” aspects. The first is a method for providing discounted media placement and marketing services to a plurality of advertisers. This method is typically operated manually, but may also be incorporated into the form of computer system operating software or in the form of a “hard-coded” instruction set. In addition to manual operations and placements, this method may be incorporated into various devices and may be coupled with a variety of hardware to provide media placement. The second principal aspect is an Internet-based method and system for providing discounted Internet media placement to a plurality of advertisers, typically in the form of software and/or manual operations, operated using a data processing system (computer). The third principal aspect is a computer program product. The computer program product generally represents computer readable code (either source or object code) stored on a computer readable medium such as an optical storage device, e.g., a compact disc (CD) or digital versatile disc (DVD), or a magnetic storage device such as a floppy disk or magnetic tape. Other, non-limiting examples of computer readable media include bard disks, read only memory (ROM), and flash-type memories. These aspects will be described in more detail below.

(3) Description

Advertising and marketing is often one of the largest expenses in any successful business. However, there is a disadvantage in the marketplace to small businesses that is a direct result of the advantages derived from economies of scale afforded by large businesses. Because bigger businesses have bigger advertising budgets, they are able to sustain more effective and more cost efficient advertising programs.

In order to help smaller businesses to compete effectively, the present invention has been devised to provide smaller businesses with several of the advantages enjoyed by larger businesses. The present invention is a novel approach to marketing and advertising, providing lower cost advertising that delivers leveraged results.

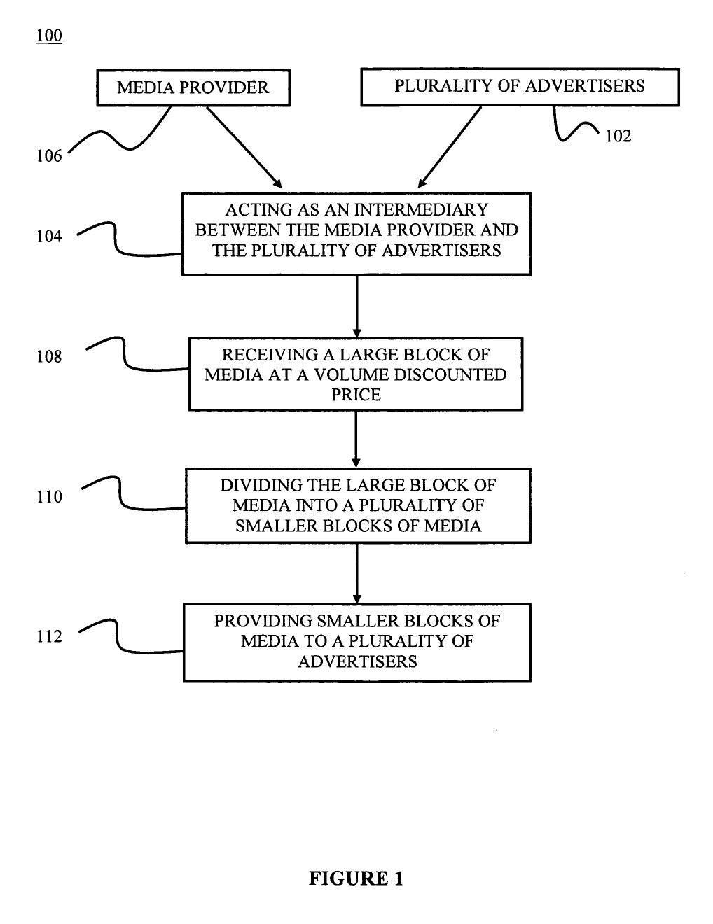

As shown in FIG. 1, the present invention relates to a method for providing discounted media placement 100 to a plurality of advertisers 102. The method comprises acting as an intermediary 104 between a media provider 106 and the plurality of advertisers 102. The media provider 106 may be any entity providing a form of mass communication, such as radio, television, tradeshows, billboards, an Internet advertisement, a sponsorship opportunity, television placement, and an Internet keyword, etc. Acting as an intermediary 104 may be performed in any suitable manner for positioning a marketer between the media provider 106 and the plurality of advertisers 102. For example, the marketer may negotiate directly with the media provider 106 for a discounted price based on volume and an added value of outsourcing sales, management, and creative development. Furthermore, the marketer may receive a large block of media at a volume-discounted price 108 from a media provider 106 and thereafter package a media program by dividing the large block of media into a plurality of suitably sized smaller media blocks 110, each smaller media block constituting a participation opportunity. For example, the marketer may provide a first participation opportunity to a first advertiser at a first volume-discounted price, and a second participation opportunity to a second advertiser at a second volume-discounted price 112.

By purchasing the larger block of media 108 at a volume-discounted price and dividing it into smaller media blocks 110, the marketer is able to provide discounted participation opportunities to smaller businesses at rates comparable to those accessible to larger businesses. Additionally, because the first and second advertisers may be placed together in the larger media block, each advertiser receives leveraged advertising.

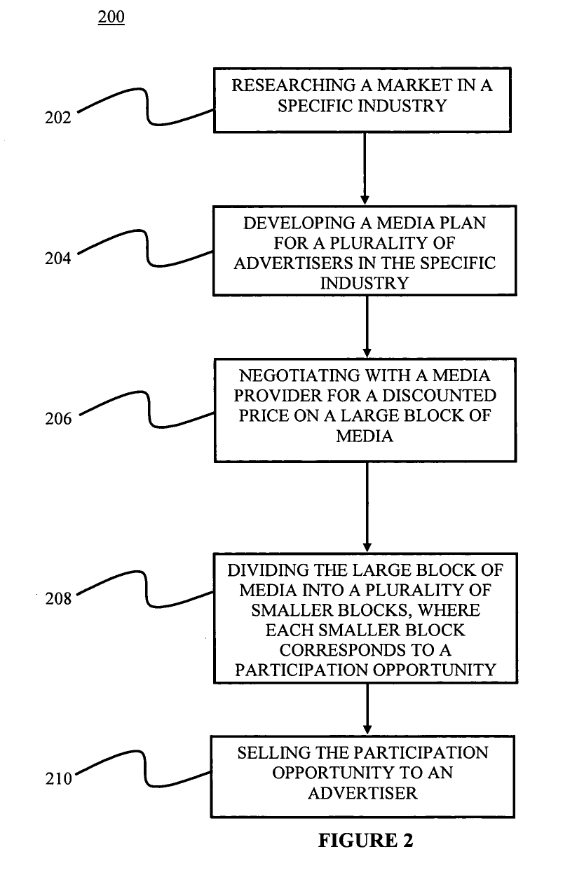

As is often the case, advertisers may be positioned to provide products and services to a particular industry. FIG. 2 illustrates a method for providing discounted marketing services to an advertiser in a specific industry 200. As shown in FIG. 2, the marketer may research a market in a specific industry 202 in order to effectively develop a media plan with a plurality of participation opportunities for that specific industry 204. The specific industry may be any suitable industry where products and services are advertised, non-limiting examples of which include the financial services industry, automotive industry, computer industry, real estate industry, and transportation industry. Additionally, the industry may be further narrowed, such as by developing a media plan specifically for a credit union segment within the financial services industry.

After having selected and researched the specific industry, the marketer may negotiate directly with the media provider for a discounted price on a large block of media 206. As was the case in the previously discussed method, the marketer may divide the large block of media into a plurality of smaller blocks, where each smaller block corresponds with the media plan and a participation opportunity 208. The participation opportunity may thereafter be sold to an advertiser 210, thereby providing leveraged media placement to advertisers at a volume-discounted price.

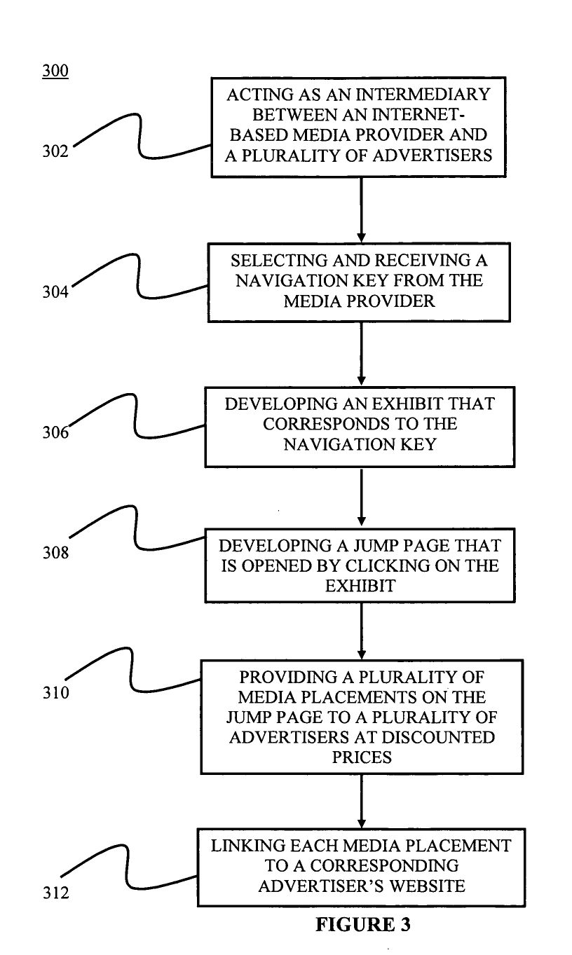

The aforementioned methods can be further applied to an Internet-based method and system. FIG. 3 illustrates an Internet-based method for providing discounted Internet media placement to a plurality of advertisers 300. Acting as an intermediary between an Internet-based media provider and the plurality of advertisers 302, the marketer may select and receive a navigation key from the media provider 304. In the Internet-based method and system, the media provider is any suitable entity providing advertising space on the Internet, a non-limiting example of which includes search engines such as Yahoo! and Google. Furthermore, the navigation key is any key for navigating a website, non-limiting examples of which include keywords, and other types of navigation such as categorical link-based navigation. The navigation key may be strategically selected as a word that customers would associate with a particular advertiser's goods or services. For example, a credit union advertiser may desire the keywords “credit union” and “loan.”

In addition to selecting a navigation key (e.g. search engine keyword), the marketer may develop an exhibit that corresponds to the navigation key 306. The exhibit is any representation concerning an advertisement, non-limiting examples of which include copy, blurbs, music, logos, and multi-media. The exhibit (e.g. copy) is retrieved when a user utilizes the navigation key, such as by inputting a selected keyword into the search engine. For example, if a user were to enter “credit union” into the search engine, a list of copy would be retrieved as the search result on a search results page, one being the copy developed by the marketer. In this example, the copy may read, “For better rates, try a credit union!”

The exhibit retrieved is linked to a jump page that is opened by clicking on the exhibit 308. The jump page is a web page that is viewable over the Internet, where the marketer may provide a plurality of media placements to a plurality of advertisers 310, allowing each advertiser to place an advertisement in their media placement. Through use of the jump page, the plurality of advertisers are able to pool their resources in order to purchase a keyword, thereby providing the advertisers with leveraged Internet media placement at a discounted price.

Due to space restrictions on a jump page, the jump page may contain space for a predetermined number of media placements. In some circumstances, it may be desirable to rotate a plurality of advertisers' exposure on the jump page when the number of media placements (advertisements) scheduled for a particular jump page exceeds the predetermined number. In such a case, a plurality of advertisers' presence on the jump page may optionally be rotated, thereby providing additional advertisers with media placement. The rotations can be based on any suitable method or in any suitable manner, non-limiting examples of which include being based upon the time present on a jump page and being based upon the number of click-throughs received. As a non-limiting example, if there were spaces for five media placements on a jump page and ten advertisers sought media placement, five advertisers may be provided with media placement on the jump page while the other five were removed from the jump page. The following minute, the five advertisers previously removed from the jump page would be provided with the media placement, while those previously provided with the media placement would be removed.

Additionally, in circumstances when rotations are instituted, some advertisers may choose to opt out of such rotations. For example, an advertiser may choose to pay higher fees to maintain a constant media placement, while other media placements on the jump page are rotated.

Furthermore, each media placement on the jump page may be linked to a desired website, such as a corresponding advertiser's website 312. The method 300 allows potential customers to utilize a navigation key (e.g. enter a keyword) with a search engine and retrieve the corresponding exhibit. The potential customer may thereafter click on the exhibit and open the jump page. Should the potential customer click on any individual advertisement on the jump page, the potential customer may then load an advertiser's website, each click and load constituting a single click-through.

The method 300 may be set up in any suitable manner allowing the marketer to monitor the system. For example, in order to maximize profits for the marketer, the marketer may sell or provide a set number of click-throughs to each individual advertiser. Once the set number of click-throughs has been reached, the individual advertiser's advertisement may be removed from the jump page. Upon removal, the individual advertiser is notified of the removal and offered an opportunity to purchase additional click-throughs. In the event that the individual advertiser purchases additional click-throughs, the advertisement may thereafter be returned to the jump page. The process by which the advertisement is removed and returned to the jump page may be through any suitable method, non-limiting examples of which include being manually removed and returned, and through an automated method.

To aid in an automated system, the method 300 may include an Internet-accessible user interface. The user interface may be configured in any suitable manner to allow a user to maintain a level of control over their media placement. For example, the user interface may be configured to allow each individual advertiser to purchase additional click-throughs and further allow each individual advertiser to select and place the corresponding media (i.e. advertisement) on the jump page.

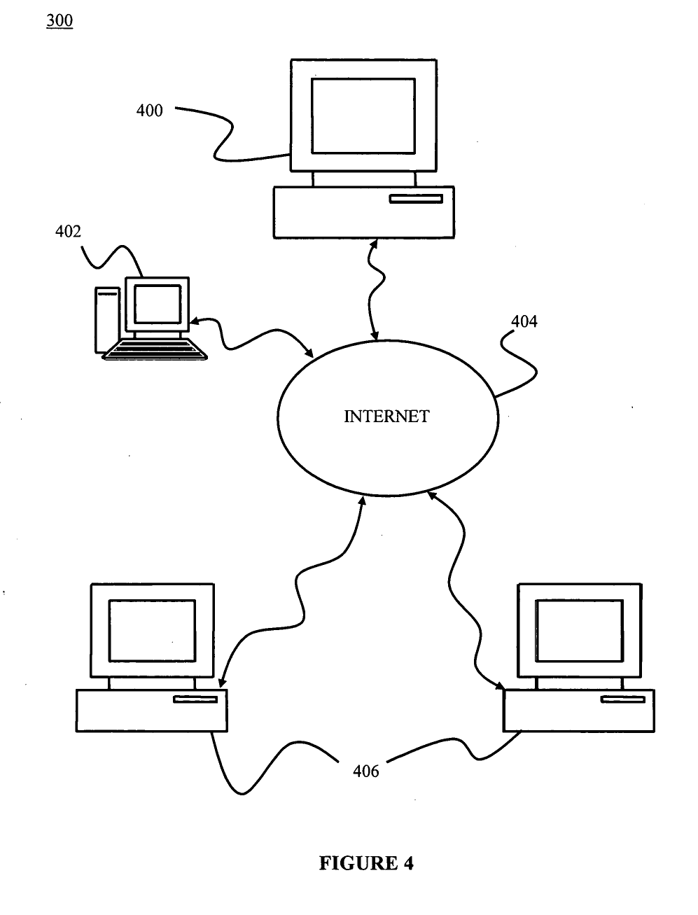

FIG. 4 illustrates a data processing system 400 (e.g. server computer) incorporating the operations of the Internet-based method 300 of FIG. 3. The method 300 may utilize a data processing system 400 for storing the jump page. The data processing system 400 and its corresponding jump page may be accessible by a user's computer 402 over the Internet 404. Additionally, when an Internet-accessible user interface is included in the system, the user interface (e.g. web page) may be stored on the data processing system 400 and may be accessible over the Internet by a plurality of advertisers 406, allowing the plurality of advertisers to interface with the system.

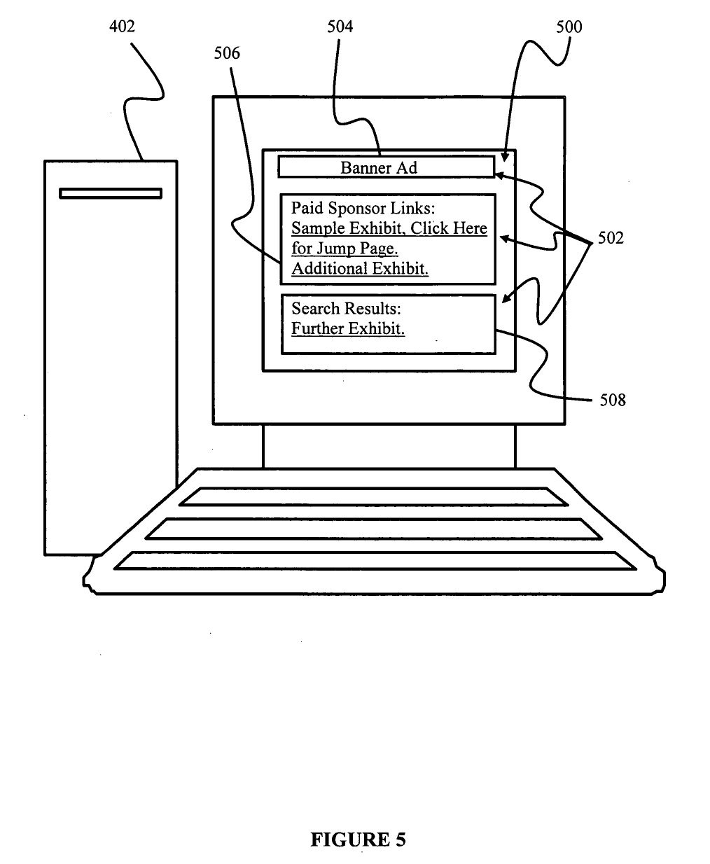

FIG. 5 illustrates a search results page 500 as seen on a user's computer 402. As previously discussed, the search results page 500 is downloaded after a user inputs a corresponding navigation key, such as a keyword, into a search engine. Typically, the search results page 500 is housed on a search engine's server and displays multiple exhibits 502. The exhibits may be in any suitable location and form, non-limiting examples of which include being a banner advertisement 504, a paid sponsor advertisement 506, and an unpaid search result advertisement 508.

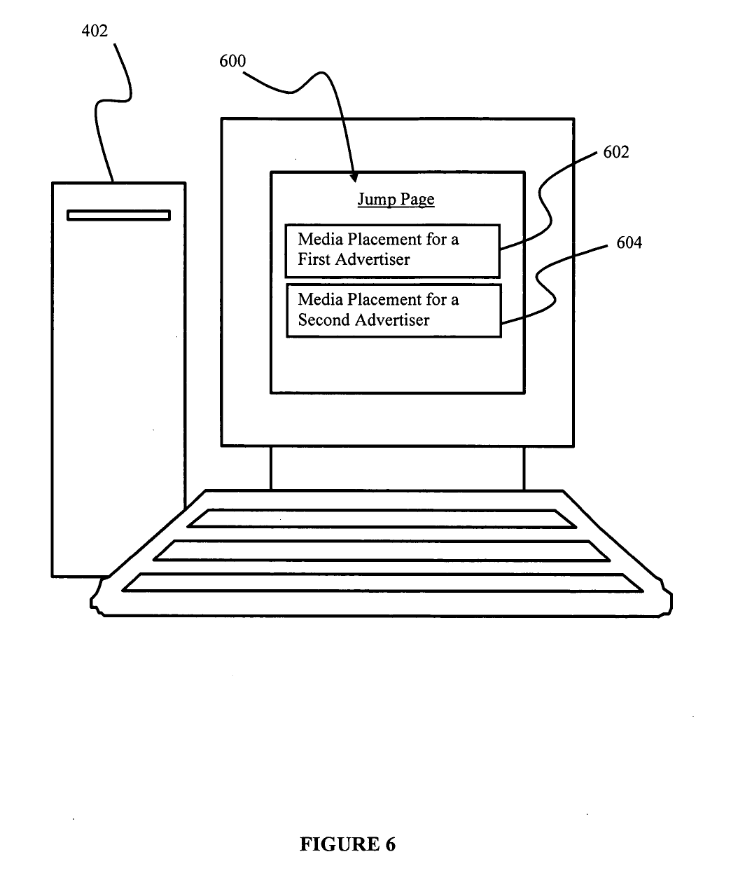

As shown in FIGS. 5 and 6, by clicking on the exhibit 502, a user's computer 402 thereafter loads the jump page 600. The jump page 600 includes media placement for a plurality of advertisers. For example, the jump page 600 may include a media placement for a first advertiser 602 and for a second advertiser 604. Each media placement may be an advertisement alone, or may further be an advertisement linked to a desired website, such as to an individual advertiser's website.

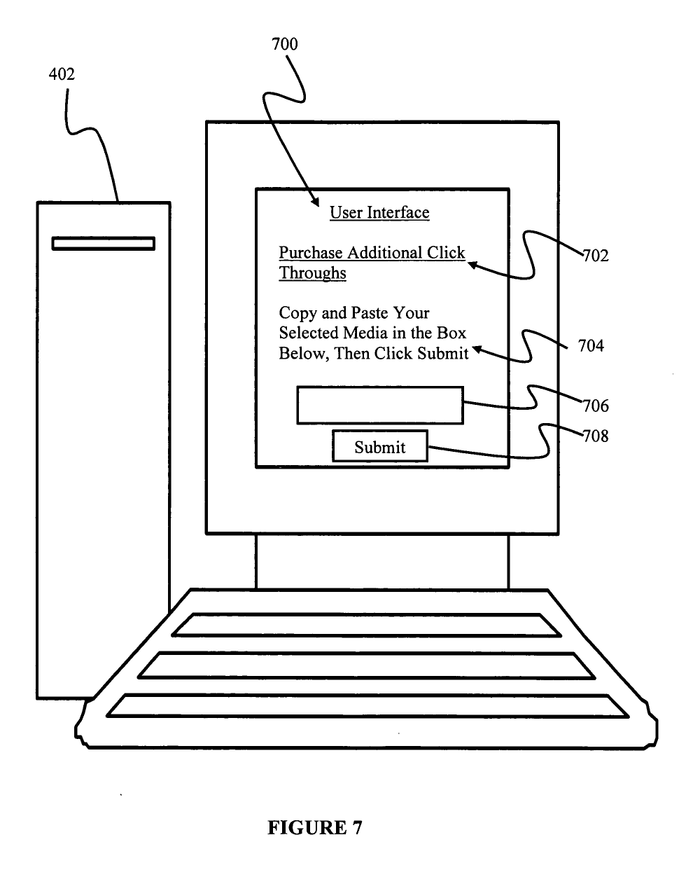

Furthermore, the system may include an Internet-accessible user interface 700. As shown in FIG. 7, the user interface 700 may be accessed over the Internet with the user's computer 402 and may be configured to allow the user to purchase additional click-throughs 702 or, in another aspect, choose the media placed 704. Purchasing additional click-throughs 702 may be accomplished through any suitable method allowing an individual to purchase a product or service online. For example, there may be a Purchase Additional Click-Through button 702 that directs a user to an order page, where the user may select a desired quantity of additional click-throughs and thereafter be directed to a check out page.

Additionally, the system may include any suitable technique to allow a user to control and choose their media placed 704. For example, the system may include an empty field 706 into which a user can copy and paste selected media. Upon submitting 708 the selected media, the user's media is thereafter placed on the jump page. In another aspect, a user may be provided with a technique to upload a file containing their selected media onto the data processing system, with the selected media thereafter placed on the jump page. These processes may be automated through any suitable technique or may require marketer intervention.

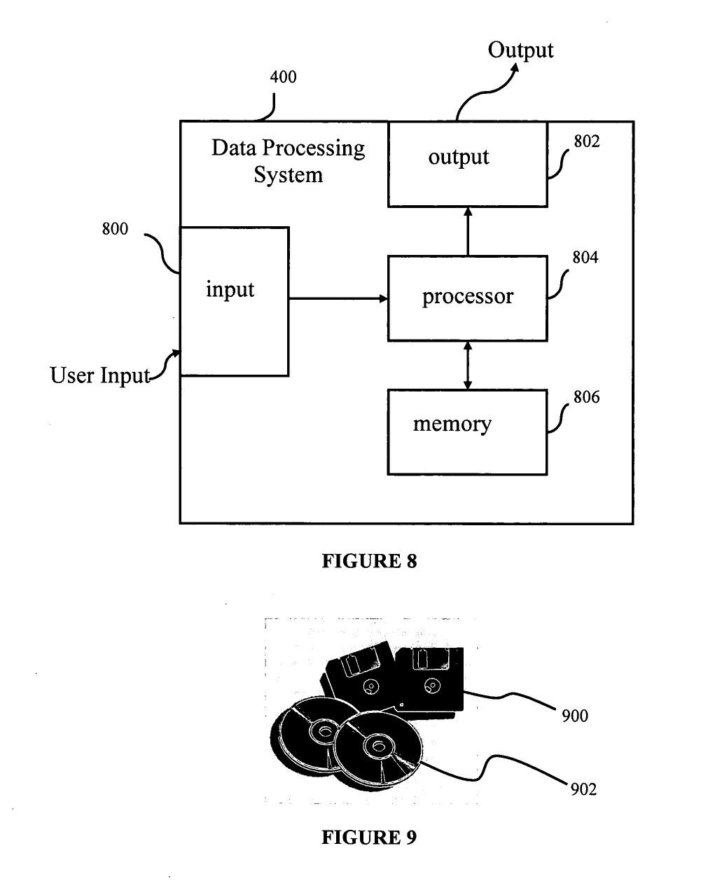

A block diagram depicting the components of the data processing system 400 used in the present invention is provided in FIG. 8. The data processing system 400 comprises an input 800 for receiving information from a marketer user, an advertiser user, and/or from other components. Information received may include input such as purchase information for buying additional click-throughs, media for placement on the jump page, input from devices such as scanners, keypads, keyboards, mice, other peripherals such as storage devices, other programs, etc. The input 800 may include multiple “ports.” An output 802 is connected with the processor for providing information for transmission to other data processing systems, to storage devices, to display devices such as monitors, to generating information necessary for delivery, and to other mechanisms for presentation in user-readable forms. Output may also be provided to other devices or other programs, e.g. to other software modules, for use therein. The input 800 and the output 802 are both coupled with a processor 804, which may be a general-purpose computer processor or a specialized processor designed specifically for use with the present invention. The processor 804 is coupled with a memory 806 to permit storage of data and software to be manipulated by commands to the processor.

An illustrative diagram of a computer program product embodying the present invention is depicted in FIG. 9. The computer program product as either a floppy disk 900 or an optical disk 902 is depicted. However, as mentioned previously, the computer program product generally represents computer readable code stored on any compatible computer readable medium.

1. A method for providing discounted media placement to a plurality of advertisers, the method comprising acts of:
acting as an intermediary between a media provider and the plurality of advertisers;
receiving a large block of media at a volume-discounted price from a media provider;
dividing the large block of media into a plurality of smaller media blocks;
providing a first smaller media block to a first advertiser at a first volume-discounted price; and
providing a second smaller media block to a second advertiser at a second volume-discounted price, whereby through receiving and dividing the large block of media into a plurality of smaller media blocks, the plurality of advertisers receive media placement at a volume-discounted price.

2. A method for providing discounted media placement to a plurality of advertisers as set forth in claim 1, wherein the act of receiving a large block of media at a volume-discounted price from a media provider, the large block of media is received in a form selected from a group consisting of radio, television, a tradeshow, a billboard, Internet, a sponsorship advertisement, television placement, a print advertisement, and an Internet keyword.

3. A method for providing discounted media placement to a plurality of advertisers as set forth in claim 2, wherein the act of acting as an intermediary between a media provider and the plurality of advertisers, further comprises an act of negotiating directly with the media provider for a discounted price based on volume.

4. A method for providing discounted media placement to a plurality of advertisers as set forth in claim 3, wherein the act of dividing the large block of media into a plurality of smaller media blocks further comprises acts of:
breaking up the large media block into the plurality of smaller media blocks, where each of the plurality of smaller media blocks is a participation opportunity; and
offering the participation opportunity to an advertiser.

5. A method for providing discounted media placement to a plurality of advertisers as set forth in claim 1, wherein the act of acting as an intermediary between a media provider and the plurality of advertisers, further comprises an act of negotiating directly with the media provider for a discounted price based on volume.

6. A method for providing discounted media placement to a plurality of advertisers as set forth in claim 1, wherein the act of dividing the large block of media into a plurality of smaller media blocks further comprises acts of:
breaking up the large media block into the plurality of smaller media blocks, where each of the plurality of smaller media blocks is a participation opportunity; and
offering the participation opportunity to an advertiser.

7. A method for providing discounted marketing services to an advertiser in a specific industry, the method comprising acts of
researching a market in a specific industry;
developing a media plan for a plurality of advertisers in the specific industry;
negotiating directly with a media provider for a discounted price on a large block of media based on volume;
dividing the large block of media into a plurality of smaller blocks, where each smaller block of media is a participation opportunity; and
selling the participation opportunity to an advertiser, whereby through negotiating for and dividing the large block of media into a plurality of smaller blocks, an advertiser purchasing a participation opportunity receives media placement at a volume-discounted price.

8. A method for providing discounted marketing services to an advertiser in a specific industry as set forth in claim 7, wherein the act of researching a market in specific industry further comprises an act of selecting an industry from a group consisting of a financial services industry, automotive industry, computer industry, real estate industry, and transportation industry.

9. A method for providing discounted marketing services to an advertiser in a specific industry as set forth in claim 8, wherein the act of developing a media plan for a plurality of advertisers in the specific industry further comprises an act of selecting credit unions as an industry segment within the financial services industry.

10. An Internet-based method for providing discounted Internet media placement to a plurality of advertisers, the method comprising acts of:
acting as an intermediary between an Internet-based media provider and the plurality of advertisers;
selecting and receiving a navigation key from the media provider;
developing an exhibit that corresponds to the navigation key and is retrieved when a user utilizes the navigation key with a search engine, the exhibit being linked to a jump page;
developing a jump page that is opened by clicking on the exhibit;
providing a first media placement on the jump page to a first advertiser at a first discounted price; and
providing a second media placement on the jump page to a second advertiser at a second discounted price, whereby through receiving a navigation key that retrieves an exhibit when used with a search engine and linking the exhibit to a jump page where the plurality of advertisers receive media placement, the plurality of advertisers receive Internet media placement at a discounted price.

11. An Internet-based method for providing discounted Internet media placement as set forth in claim 10, further comprising an act of linking each media placement to a desired website, thereby allowing a user to click on the media placement and load information from the desired website, each click and load constituting a single click-through.

12. An Internet-based method for providing discounted Internet media placement as set forth in claim 11, further comprising an act of selling a set number of click-throughs to each individual advertiser.

13. An Internet-based method for providing discounted Internet media placement as set forth in claim 12, further comprising an act of removing the individual advertiser's media placement from the jump page when the set number has been reached.

14. An Internet-based method for providing discounted Internet media placement as set forth in claim 13, further comprising acts of:
notifying the individual advertiser of the removal; and
offering an opportunity to purchase additional click-throughs.

15. An Internet-based method for providing discounted Internet media placement as set forth in claim 14, further comprising an act of returning the individual advertiser's media placement to the jump page after having purchased additional click-throughs.

16. An Internet-based method for providing discounted Internet media placement as set forth in claim 15, wherein the acts of removing the media placement from the jump page and returning the media placement to the jump page are automated.

17. An Internet-based method for providing discounted Internet media placement as set forth in claim 16, further comprising an act of providing an Internet-accessible user interface.

18. An Internet-based method for providing discounted Internet media placement as set forth in claim 17, further comprising an act of configuring the user interface to allow each individual advertiser to purchase additional click-throughs.

19. An Internet-based method for providing discounted Internet media placement as set forth in claim 18, further comprising an act of configuring the user interface to allow each individual advertiser to select media to be placed on the jump page.

20. An Internet-based method for providing discounted Internet media placement as set forth in claim 19, further comprising an act of rotating a plurality of advertisers' exposure on the jump page, where the jump page contains space for a predetermined number of media placements such that when that number is exceeded, a plurality of advertisers' presence on the jump page is rotated, thereby providing additional advertisers with media placement at a volume-discounted price.

21. An Internet-based method for providing discounted Internet media placement as set forth in claim 10, further comprising an act of providing an Internet-accessible user interface.

22. An Internet-based method for providing discounted Internet media placement as set forth in claim 21, further comprising an act of configuring the user interface to allow each individual advertiser to select media to be placed on the jump page.

23. An Internet-based method for providing discounted Internet media placement as set forth in claim 10, further comprising an act of rotating a plurality of advertisers' exposure on the jump page, where the jump page contains space for a predetermined number of media placements such that when that number is exceeded, a plurality of advertisers' presence on the jump page is rotated, thereby providing additional advertisers with media placement at a volume-discounted price.

24. An Internet-based system for providing discounted Internet media placement to a plurality of advertisers, the system comprising:
a data processing system for storing a jump page, the jump page including a first media placement for a first advertiser stored at a first discounted price and a second media placement for a second advertiser stored at a second discounted price, the jump page being loaded by clicking on an exhibit that corresponds to a navigation key, where through-linking the exhibit to a jump page where a plurality of advertisers receive media placement, the plurality of advertisers receive Internet media placement at a discounted price.

25. An Internet-based system for providing discounted Internet media placement as set forth in claim 24, wherein each media placement on the data processing system is linked to a desired website on an corresponding server computer, allowing a user to click on the media placement and load the desired website, each click and load constituting a single click-through.

26. An Internet-based system for providing discounted Internet media placement as set forth in claim 25, wherein the system includes a counter that stores the number of click-throughs, and when the counter reaches a predetermined level, the advertiser is notified and offered an opportunity to purchase additional click-throughs.

27. An Internet-based system for providing discounted Internet media placement as set forth in claim 26, wherein each individual advertiser purchases a set number of click-throughs, such that when the set number is reached, the system removes the individual advertiser's media placement from the jump page, and where through purchasing additional click-throughs, the system returns the individual advertiser's corresponding media placement to the jump page.

28. An Internet-based system for providing discounted Internet media placement as set forth in claim 27, wherein the system by which the media placement is removed from the jump page and by which the media placement is returned to the jump page is automated.

29. An Internet-based system for providing discounted Internet media placement as set forth in claim 28, wherein the data processing system further comprises an Internet-accessible user interface.

30. An Internet-based system for providing discounted Internet media placement as set forth in claim 29, wherein the user interface is configured to allow each individual advertiser to purchase additional click-throughs.

31. An Internet-based system for providing discounted Internet media placement as set forth in claim 30, wherein the user interface is configured to allow each individual advertiser to select media to be placed on the jump page.

32. An Internet-based system for providing discounted Internet media placement as set forth in claim 31, further comprising a means for rotating a plurality of advertisers' exposure on the jump page, where the jump page contains space for a predetermined number of media placements such that when that number is exceeded, a plurality of advertisers' presence on the jump page is rotated, thereby providing additional advertisers with media placement at a volume-discounted price.

33. An Internet-based system for providing discounted Internet media placement as set forth in claim 24, wherein the data processing system further comprises an Internet-accessible user interface.

34. An Internet-based system for providing discounted Internet media placement as set forth in claim 33, wherein the user interface is configured to allow each individual advertiser to select media to be placed on the jump page.

35. An Internet-based system for providing discounted Internet media placement as set forth in claim 24, further comprising a means for rotating a plurality of advertisers' exposure on the jump page, where the jump page contains space for a predetermined number of media placements such that when that number is exceeded, a plurality of advertisers' presence on the jump page is rotated, thereby providing additional advertisers with media placement at a volume-discounted price.

36. A computer program product for providing discounted Internet media placement to a plurality of advertisers, the computer program product comprising computer-readable instructions encoded on a computer-readable medium for causing a server computer to:
receive input information regarding an advertisement purchased on a search engine;
receive requests for media placement from prospective advertisers;
sell media placements to the advertisers at a determined price;
receive advertisements from the advertisers to which media placements were sold;
receive a download request from a user's computer, where the download request is from a user searching on the search engine;
generate a jump page partitioning an advertising page into a plurality of media placements where, when loaded, the jump page displays media placements purchased by advertisers.

37. A computer program product for providing discounted Internet media placement to a plurality of advertisers set forth in claim 36, further comprising a means for linking each media placement to a corresponding advertiser's website, causing a user's computer to load a page from the respective advertiser's website when a user click's on the media placement, each click and load constituting a single click-through.

38. A computer program product for providing discounted Internet media placement to a plurality of advertisers as set forth in claim 37, further comprising means for selling a set number of click-throughs to each individual advertiser.

39. A computer program product for providing discounted Internet media placement to a plurality of advertisers as set forth in claim 38, further comprising means for removing the individual advertiser's media placement from the jump page when the set number has been reached.

40. A computer program product for providing discounted Internet media placement to a plurality of advertisers set forth in claim 39, further comprising means for notifying the individual advertiser of the removal; and a means for offering an opportunity to purchase additional click-throughs.

41. A computer program product for providing discounted Internet media placement to a plurality of advertisers as set forth in claim 40, further comprising means for returning the individual advertiser's media placement to the jump page after having purchased additional click-throughs.

42. A computer program product for providing discounted Internet media placement to a plurality of advertisers set forth in claim 41, further comprising means for providing an Internet-accessible user interface.

43. A computer program product for providing discounted Internet media placement to a plurality of advertisers set forth in claim 42, further comprising means for configuring the user interface to allow each individual advertiser to purchase additional click-throughs.

44. A computer program product for providing discounted Internet media placement to a plurality of advertisers as set forth in claim 43, further comprising means for configuring the user interface to allow each individual advertiser to select media to be placed on the jump page.

45. A computer program product for providing discounted Internet media placement to a plurality of advertisers as set forth in claim 44, further comprising a means for rotating a plurality of advertisers' exposure on the jump page, where the jump page contains space for a predetermined number of media placements such that when that number is exceeded, a plurality of advertisers' presence on the jump page is rotated, thereby providing additional advertisers with media placement at a volume-discounted price.

46. A computer program product for providing discounted Internet media placement to a plurality of advertisers set forth in claim 36, further comprising means for providing an Internet-accessible user interface.

47. A computer program product for providing discounted Internet media placement to a plurality of advertisers as set forth in claim 46, further comprising means for configuring the user interface to allow each individual advertiser to select media to be placed on the jump page.

48. A computer program product for providing discounted Internet media placement to a plurality of advertisers as set forth in claim 36, further comprising a means for rotating a plurality of advertisers' exposure on the jump page, where the jump page contains space for a predetermined number of media placements such that when that number is exceeded, a plurality of advertisers' presence on the jump page is rotated, thereby providing additional advertisers with media placement at a volume-discounted price.

49. A method for providing discounted media placement to a plurality of advertisers, the method comprising acts of:
acting as an intermediary between a media provider and the plurality of advertisers;
receiving a large block of media at a volume-discounted price from a media provider;
dividing the large block of media into a plurality of smaller media blocks;
providing the plurality of smaller media blocks to a plurality of advertisers at volume-discounted prices, whereby through receiving and dividing the large block of media into a plurality of smaller media blocks, the plurality of advertisers are able to receive media placement at a volume-discounted price.
